(19) United States
(12) Patent Application Publication
(10) Pub. No.: US 2017/0039212 A1
(43) Pub. Date: Feb. 9, 2017

(54) Method and system for managing client data replacement

(71) Applicant: UTOMIK BV, Eindhoven (NL)

(72) Inventors: Jasper Van VIJN, Eindhoven (NL); Rob Van GULIK, Eindhoven (NL); Mark SCHRODERS, Eindhoven (NL)

(73) Assignee: Utomik BV

(21) Appl. No.: 14/817,773

(22) Filed: Aug. 4, 2015

(51) Int. Cl. G06F 17/30; H04L 29/08; H04L 29/06; G06F 9/445

(52) U.S. Cl. CPC G06F 17/30115; G06F 8/65; H04L 67/06; H04L 67/42

(57) ABSTRACT

A computer-implemented method of managing replacement of a data file residing on a client computer to correspond to a new version residing on a server computer, the data file comprising one or more parts, the parts being sequentially ordered and grouped in plural consecutive chunks. The method comprises identifying those parts of the data file which are identical in the data file and the new version, identifying chunks comprising parts which are so identical, creating replacement chunks comprising parts not comprised in the chunks identified in the previous step, and causing only the replacement chunks to be transmitted to the client computer over a network.

### FIELD OF THE INVENTION

The invention relates to a computer-implemented method of managing replacement of a data file residing on a client computer to correspond to a new version residing on a server computer, the data file comprising one or more parts, the parts being sequentially ordered and grouped in plural consecutive chunks.

The invention further relates to a corresponding system and computer program.

### BACKGROUND OF THE INVENTION

As software is growing to become more and more complex, managing the issue of updating or ‘patching’ software becomes more and more important. It is often not feasible to issue updates by providing a completely new version of the software. Instead, so-called patches are issued that contain only certain changes, removals or additions to elements of the software already installed on the user's equipment.

A simple approach to patch software is to issue updates on the file level: those files of the software that have been modified are made available to the user, who replaces the old versions with the new. For example, U.S. Pat. No. 6,918,113 discloses a process for patching files that works on a file basis, where files are assigned identifiers, and a new version of a file gets a fresh identifier, making sure that when a user tries to access such a changed file, the correct and newest version of the file is downloaded. Such an approach is not always feasible, especially when updating software over a network. Files may be very large, requiring a potentially time-consuming and/or expensive download. An alternative is to issue patches on the byte level: the patch indicates which bytes of which files have been changed, e.g. by providing bytes to be added or replaced or by indicating which bytes to remove.

An important aspect of patching is that multiple patches may be available for one file. This usually requires applying all the patches in order, which is called “incremental patching”. For example, if the user has patch version 1 of a particular file and wishes to be updated to patch version 3, he usually has to apply patch version 2 first and only then apply patch version 3. This error prone manual patching process has only recently been replaced by an automated process that still follows the same steps in most software patching environments.

In contexts where software is downloaded over a network, usually patching is performed on the file level: if a part of a file has changed, the file needs to be downloaded again when the software needs to access it. Many such so-called file streaming systems break up larger files into smaller parts for each version of the application, because this reduces the amount of content that needs to be sent to another location. This process is usually referred to as chunking. Parts or chunks that remain the same after a patch do not need to be updated when the user accesses this part of the file.

In this context, existing patching systems do not work very well due to the fact that it is desirable to have the software work before all of the files have been downloaded and/or updated. Downloading a complete file again when only a small part of it has changed is wasteful and time-consuming. Patching on the byte level is not practical, because the content on the destination machine is not in a known state. For example, content may be missing because it was not available in a previous version of the application, or simply because the application user has not tried to access it yet. Further, it is desirable to limit users to downloading only those files they actually need to use.

A common approach is to break up large files into smaller parts, allowing downloading or patching to be done at the part level. However, this only works when new content is to be appended after already-downloaded parts. If some content of a file is inserted to or deleted from an already-downloaded part, this approach is no longer possible. In more general terms, a technical problem in the prior art is how to allow patching of parts (or ‘chunks’) of a file in a manner that minimizes the number of parts that need to be replaced.

### SUMMARY OF THE INVENTION

The invention solves or at least reduces the above-mentioned technical problem in a method comprising the steps of (a) identifying those parts of the data file which are identical in the data file and the new version, (b) identifying chunks comprising parts which are so identical, (c) creating replacement chunks comprising parts not comprised in the chunks identified in the previous step, and (d) causing only the replacement chunks to be transmitted to the client computer over a network.

In this manner, it is achieved that fewer chunks are transmitted than in the prior art. A data file is made up out of many parts, which are grouped together into chunks. By identifying chunks in the new version that are identical to chunks in the old version of the file, the invention allows for only transmitting those chunks with new parts, thus saving the transmission of unnecessary chunks.

An additional advantage of the invention is that incremental patching can be avoided. If it is known that the data file on the client is at version 3 and the server version is at version 7, one can simply identify parts identical between versions 3 and 7 and create replacement chunks for the remainder. This avoids having to download and apply replacement chunks for versions 4, 5 and 6.

This approach is not known in the prior art. U.S. Pat. No. 8,117,173 describes an efficient chunking method that can be used to keep files updated between a remote machine and a local machine over a network. The chunking method in this patent is used to efficiently sync changes made on either side of the network connection to the other side, but does not consider updates to parts of individual files. U.S. Pat. No. 8,909,657 similarly does not consider updates to parts of individual files. While this patent does consider the content of a file, it merely performs different types of chunking based on the type of file, e.g. an audio file versus software versus a text document.

In addition to the area of patching mentioned in the introduction, the invention may find application in the area of downloading large data files where a network disruption or other interruption may cause the data file to be received only partially. By grouping the parts of the received file into chunks, the method of the invention allows for a download of only the missing and/or corrupted parts.

Preferably the chunks are represented as patterns and the hash-based Rabin-Karp algorithm is employed to identify the chunks which are so identical. This is an efficient and fast algorithm to identify such chunks in two versions of a data file.

In an embodiment chunks below a predetermined minimum part size are merged and chunks above a predetermined maximum size are split in half. Preferably the minimum and maximum sizes are identical, with chunks more than 1.5 times of this size being split and chunks less than 0.5 times of this size are merged. Very large chunks are inefficient, and very small chunks can lead to fragmentation over time. These sizes have been found in practice to provide particularly useful results against inefficiency and fragmentation, and provide ease of implementation.

In an embodiment the data file comprises at least one part that is contiguous, the method comprising identifying said part as a whole as identical or not. An advantage of this embodiment is that such data, such as images, audio recordings or textures, is known to be unlikely to change. Therefore it makes sense to treat such data as a whole, ie. the whole image, recording or texture, as a chunk instead of creating chunks for parts of such data. Of course, it is still possible to apply the method of the invention to such part in order to identify chunks of it that are unaffected.

Preferably the data file has been compressed using a compression algorithm prior to the grouping. In such a case the compression algorithm is to be applied to the new version after step (a).

The invention further provides for a system corresponding to the method of the invention. The invention further provides for a computer-readable storage medium comprising executable code for causing a computer to perform the method of the invention.

### BRIEF DESCRIPTION OF THE DRAWINGS

In the drawings:

FIG. 1 schematically illustrates an arrangement comprising a server system and plural client systems;

FIG. 2 schematically shows the server in more detail;

FIG. 3 schematically illustrates the steps performed by the server in accordance with the invention;

FIGS. 4(a)-(e) illustrate the process of chunking of step 310 from FIG. 3 in more detail.

In the figures, same reference numbers indicate same or similar features. In cases where plural identical features, objects or items are shown, reference numerals are provided only for a representative sample so as to not affect clarity of the figures.

### DETAILED DESCRIPTION OF CERTAIN EMBODIMENTS

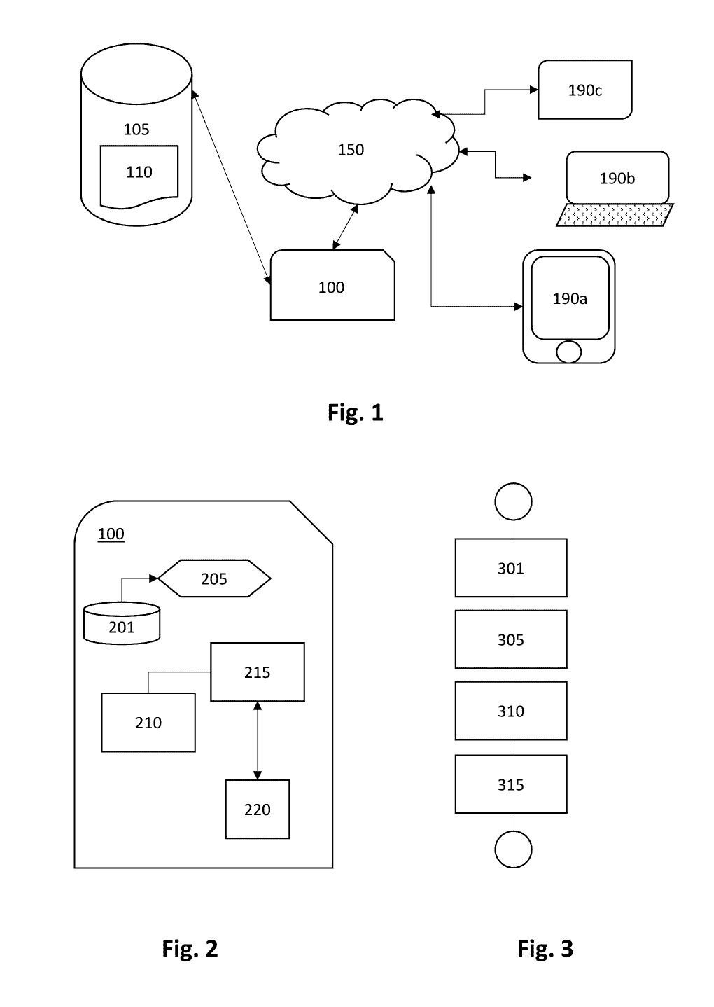

FIG. 1 schematically illustrates an arrangement comprising a server system 100 and plural client systems 190a, 190b, 190c. The server 100 and clients are connected over a network 150 such as the internet. The server 100 has access to storage medium 105 on which is stored a software application 110. The clients 190a, 190b, 190c are configured to download this software application 110 from the server 100 and to execute the application 110 without having in its possession the entire software application. As such, this set-up is well known and will not be elaborated upon further.

To facilitate the above execution of the application 110 by the clients 190a, 190b, 190c, the server 100 is configured for dividing the application 110 into small parts, hereafter known as chunks. The size of the chunks can be chosen arbitrarily.

Typically a balance must be struck between larger and smaller. The larger a chunk is, the higher the chance its download might fail. However, the smaller a chunk is, the more chunks need to be downloaded. In many networking arrangements a significant overhead is associated with many small downloads. How the chunks are sized and chosen is discussed in more detail below.

To start execution of application 110, a certain number of chunks will be required. Determining which chunks are required, depends on the application. Factors to employ to make this determination include the available bandwidth and the total time that a user has already spent inside the application 110 before this session. After downloading an initial set of chunks, the application is started, and the client system keeps downloading chunks in the background as necessary. The client system in question may have acquired certain chunks beforehand, e.g. local caching or stored on a permanent storage medium. If such chunks are already available, they may be loaded into main memory before the application 110 requests them to increase application loading speed.

Note that while the below disclosure describes the invention with reference to a software application, the invention may equally well find application with other types of data files. For example, a video file or a large text can be divided into chunks as described above just as well.

FIG. 2 schematically shows the server 100 in more detail. The server 100 comprises non-volatile storage medium 201 for storing software to cause the server to function, and a processor 205 for executing this software. In accordance with the invention, a chunking module 210 is provided for dividing the application 110 into chunks. Further, the server comprises a replacement management module 215 configured for replacing on a client system 190a, 190b, 190c an instance of the application 110 with the instance of that application 110 available to the server 200. The aim here is not to simply transmit all data from the server instance to the client and to replace all data of the client instance, but instead to only transmit those chunks of the server instance which differ from the client instance. Networking module 220 is provided to send and receive data to and from the client systems 190a, 190b, 190c.

The server 200 performs the following steps, illustrated in FIG. 3. First, at 301 the module 215 identifies those parts of the application 110 which are identical in the server instance and the client instance, as well as those parts that differ. This requires knowledge of the version of the application 110 available to the client system.

Several ways exist to achieve this knowledge. In one embodiment, versions of the application are numbered in some fashion, and the client 190a communicates the version number of its version to the server. The server 200 then has available copies of all versions of the application, and is thereby able to make the identification. Alternatively, the server 200 may be configured to keep track of all updates to an initial version of the application 110 as sent to client 190a, allowing it to identify the content of the client instance of the application 110.

In an optional embodiment, the method is practiced on a compressed version of the application 110. In this manner the data file has been compressed using a compression algorithm prior to the grouping, and the compression algorithm is applied to the new version after step 301.

In step 305, the module 215 identifies replacement chunks comprising parts not comprised in the chunks identified in step 301. In a preferred embodiment, this step comprises various stages. A first stage utilizes the hash-based Rabin-Karp algorithm. A person of ordinary skill in the art will recognize that there are many alternatives, such as a naïve brute force implementation, Aho-Corasick, Knuth-Morris-Pratt, Boyer and Moore, or tree-based algorithms.

A second stage comprises converting a set of matches describing every location where chunks from the client instance were found in the server instance (including overlaps), into a set of non-overlapping client chunks as they occur in the server instance, utilizing a divide and conquer optimization that is often seen in collision detection algorithms; creating collision islands before considering actual pairs of chunks. This optimization provides better results.

Additional chunks may optionally be added in a third stage for all gaps that were left after completion of stage 2. Preferably, in this third stage, chunks below a predetermined minimum part size are merged and chunks above a predetermined maximum size are split in half. Preferably the minimum and maximum sizes are identical, with chunks more than 1.5 times of this size being split and chunks less than 0.5 times of this size are merged.

In a further embodiment the data being chunked comprises at least one part that is contiguous data, such as audio, video or images. In this embodiment, said part is considered as a whole as identical or not instead of using the above more advanced approach to chunking.

In step 310, the module 215 actually creates the replacement chunks. In step 315, the chunks are transmitted by networking module 220 for reception by the client system in question.

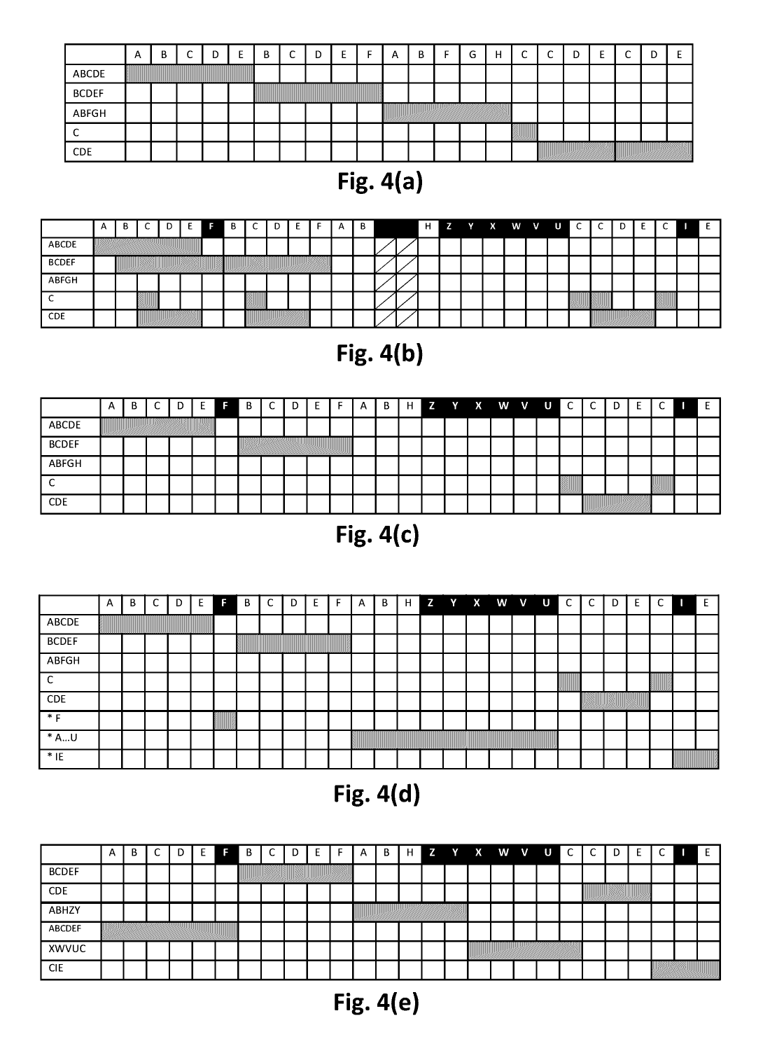

FIGS. 4(a)-(e) illustrate the process of chunking of step 310 in more detail. First, FIG. 4(a) illustrates an example client instance of the application 110. The top row denotes the data in the application, each letter denoting one data element, where the same letter indicates an identical element. For example, data element A occurs two times but data element B occurs three times. The grey parts illustrate how in a previous instance the application 110 was divided into chunks, with the leftmost column summarizing the content of each chunk.

FIG. 4(b) illustrates the result of a comparison between client and server instances of application 110. Changes have been made. The server instance is newer and has insertions “F” and “ZYXWVU”, removal of “FG” and a change of “D” to “I”.

These changes are indicated with a striped background. In the three-stage approach described above, this is the result of stage one. These results are achieved as a pattern matching or string matching problem, where a set of chunks is to be found that fully covers the old version, i.e. the client instance. Various algorithms are available for this purpose, from a naïve brute force algorithm to more advanced algorithms such as Knuth-Morris-Pratt, Boyer and Moore, Aho-Corasick or the above-mentioned hash-based search by Rabin-Karp.

FIG. 4(c) illustrates an optimization of the chunking process matches by choosing best coverage with non-overlapping chunks. This is stage two of the three-stage approach. As can be seen in FIG. 4(b), the result of the previous stage may result in duplicate findings. This results in more chunks than needed for an efficient transmission. The challenge here is to find a set of non-overlapping chunks in the client instance that cover as much of the server instance as possible.

A preferred algorithm to solve this challenge is as follows.

1. Assume there are W matches. Sort all matches by position.

2. Use sweep and prune to create Q collision islands of size Vi, with i ranging from 1 to Q. Vi thus is the number of matches in collision island i.

3. Per island, find optimal coverage. The process steps are:
i. Consider if the island of size Vi is larger than a predetermined maximum. If Vi is not larger, then use a brute-force technique. This considers every combination, returns a set of non-overlapping options and chooses the best one. One obvious optimization: once an overlapping pair is found, disregard all combinations that use that pair. However if Vi is larger than the maximum, use a greedy method. This will create a set of the largest matches that do not overlap.
i. Sort the islands descending by size.
ii. Starting with the largest, check the current match with already accepted overlaps. If there is no overlap, accept this one as well.

4. Convert the set of non-overlapping matches back to chunks.

This algorithm produces a set of non-overlapping chunks in the client instance that cover part of the server instance. Collision islands are often used in collision detection, this is an optimization. The approach of finding overlaps will also work without it, just not as well.

FIG. 4(d) illustrates the third stage of the three-stage approach. Here chunks are assigned for any gaps that occurred at the end of stage two. In formal terms, there now exists a set of chunks Rc in the client instance that are present in the server instance s. Coverage is not complete, which means identification of gaps in coverage to add chunks. The process here is as follows:

0. Sort the set of chunks Rc according to position.

1. For each chunk, compare its left side with the right side of the previous chunk.

2. If there is a gap between the current chunk and the previous chunk, then create a new chunk between the previous and the current.

3. Check for a tail gap, i.e. a final missing chunk at the rightmost side of the last chunk. If such a chunk is missing, add it.

FIG. 4(e) illustrates the process of splitting chunks that are too large and merging chunks that are too small. In this example, the large chunk “ABHZYXWVU” of FIG. 4(d) is split into “ABHZY” and “XWVU” and the small chunks “F”, “C”, “C” and “IE” are merged with larger chunks that precede or follow the small chunks in question. The chunks “BCDEF” and “CDE” from FIG. 4(a) remain intact. As a result, now in step 315 only chunks “ABHZY”, “ABCDEF”, “XWVUC” and “CIE” need to be transmitted. In a preferred embodiment the process is as follows:

1. Determine a preferred size for chunks, denoted as P.

2. Determine a minimum size P1 and maximum size Ph. For example, P1=0.5 P, Ph=1.5 P.

3. Sort chunks by position.

4. Split step: For each chunk with size>Ph, split it into size/P chunks of size P, and a size % P tail.

5. Merge step. For each each chunk with size<P1, merge it with one of its neighbors.

6. Repeat the step and merge steps until there are no more chunks that satisfy the conditions for merging or splitting.

The merge step ideally should seek a compromise between leaving many small chunks (which is inefficient) and creating many new chunks (which means more transmission). Several options for merging exist. Consider candidate chunk Ci that's considered too small. Examples of merging strategies would be:

For example, one can simply merge a chunk with its next neighbour. This is simple to implement. One may also seek to merge with its previous neighbour, although this has the downside of being somewhat greedy. More advanced choices are made based on an evaluation of which neighbour is ‘best’, for some definition of ‘best’.

In one embodiment, the invention uses the following approach:

1. If only the left neighbour chunk is new and the size after merge is smaller than Ph, merge with the left neighbour chunk.

2. If only the right neighbour chunk is new, merge with the right neighbour chunk.

3. If both chunks are new, or both are old, merge with the smallest neighbour or the left neighbour if both are of equal size.

In the example of FIGS. 4(d) and 4(e), this means the following:

1. at the front, new chunk “F” is left-merged with old chunk “ABCDE” (condition 3)

2. in the middle, old chunk “C” is left-merged with split-result “XWVU” (condition 1)

3. at the end, old chunk “C” is right-merged with (condition 2).

It is to be noted that in this particular example, the number of reused chunks is reduced considerably, but this is mostly because there was a small chunk to begin with. Because the final chunks are of ‘reasonable’ size, the next update of this large file should be simpler; this was a ‘difficult’ example to show all cases.

### Closing Notes

The above provides a description of several useful embodiments that serve to illustrate and describe the invention. The description is not intended to be an exhaustive description of all possible ways in which the invention can be implemented or used. The skilled person will be able to think of many modifications and variations that still rely on the essential features of the invention as presented in the claims. In addition, well-known methods, procedures, components, and circuits have not been described in detail.

Some or all aspects of the invention may be implemented in a computer program product, i.e. a collection of computer program instructions stored on a computer readable storage device for execution by a computer. The instructions of the present invention may be in any interpretable or executable code mechanism, including but not limited to scripts, interpretable programs, dynamic link libraries (DLLs) or Java classes. The instructions can be provided as complete executable programs, as modifications to existing programs or extensions (“plugins”) for existing programs. Moreover, parts of the processing of the present invention may be distributed over multiple computers or processors for better performance, reliability, and/or cost.

Storage devices suitable for storing computer program instructions include all forms of non-volatile memory, including by way of example semiconductor memory devices, such as EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. Transmission of the computer program product by e-mail is of course also possible.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the invention. Any reference to a claim feature in the singular shall not exclude the presence of a plurality of this feature. The word “means” in a claim can refer to a single means or to plural means for providing the indicated function.

1. A computer-implemented method of managing replacement of a data file residing on a client computer to correspond to a new version residing on a server computer, the data file comprising one or more parts, the parts being sequentially ordered and grouped in plural consecutive chunks, the method comprising the steps of
a) identifying those parts of the data file which are identical in the data file and the new version,
b) identifying chunks comprising parts which are so identical,
c) creating replacement chunks comprising parts not comprised in the chunks identified in the previous step, and
d) causing only the replacement chunks to be transmitted to the client computer over a network.

2. The method of claim 1, in which the chunks are represented as patterns and the hash-based Rabin-Karp algorithm is employed to identify the chunks which are so identical.

3. The method of claim 1, in which chunks below a predetermined minimum part size are merged and chunks above a predetermined maximum size are split in half.

4. The method of claim 1, in which the data file comprises at least one part that is contiguous, the method comprising identifying said part as a whole as identical or not.

5. The method of claim 1, the data file having been compressed using a compression algorithm prior to the grouping, and applying the compression algorithm to the new version after step a.

6. A server computer system for managing replacement of a data file residing on a client computer to correspond to a new version residing on the server computer system, the data file comprising one or more parts, the parts being sequentially ordered and grouped in plural consecutive chunks, the server computer system comprising a replacement management configured for:
a) identifying those parts of the data file which are identical in the data file and the new version,
b) identifying chunks comprising parts which are so identical,
c) creating replacement chunks comprising parts not comprised in the chunks identified in the previous step, and
d) causing a networking module to transmit only the replacement chunks to the client computer over a network.

7. A computer program product comprising executable code for causing a computer to perform the method of claim 1.
